(19) United States
(12) Patent Application Publication
(10) Pub. No.: US 2011/0231097 A1
(43) Pub. Date: Sep. 22, 2011

(54) ACOUSTIC RADIAL PROFILING VIA FREQUENCY DOMAIN PROCESSING

(75) Inventor: Jennifer A. Market, Tomball, TX (US)

(73) Assignee: Halliburton Energy Services, Inc., Houston, TX (US)

(21) Appl. No.: 12/595,294

(22) PCT Filed: Apr. 19, 2007
(86) PCT No.: PCT/US07/09795

§ 371 Date: May 23, 2011

(51) Int. Cl. G06F 19/00; E21B 49/00

(52) U.S. Cl. 702/6; 73/152.16

(57) ABSTRACT

A tool and processing system to provide an acoustic radial profile. A frequency semblance is performed on received time signals obtained from an array of acoustic receivers (FIG. 2, blocks 204, 206) so as to provide a set of frequency semblance values in frequency-slowness coordinate space. These frequency semblance values are transformed to a set of frequency semblance values in wavelength-slowness coordinate space (FIG. 2, block 208), from which a radial profile (FIG. 2, block 210) may be provided by utilizing a relationship between wavelength and radial depth.

### FIELD

The present invention relates to well logging and drilling tools, and more particularly, to acoustic profiling of formations.

### BACKGROUND

Acoustic tools are commonly used in well logging to provide information about sound slowness (inverse of velocity) in formations. A tool may have one or more acoustic transmitters, and one or more acoustic receiver arrays. Based upon the received signals, the slowness may be extracted by signal processing. From the slowness of compression and shear acoustic waves, various formation properties may be measured, such as pore pressure, porosity, presence of fractures, to name just a few examples.

It is useful to provide slowness information of the formation over various radial distances (or depths) from the tool.

### BRIEF DESCRIPTION OF THE DRAWINGS

FIG. 1 illustrates a well drilling and logging system according to an embodiment of the present invention.

FIG. 2 illustrates a method to provide a slowness radial profile according to an embodiment of the present invention.

FIGS. 3A and 3B illustrate semblance plots according to an embodiment of the present invention.

### DESCRIPTION OF EMBODIMENTS

In the description that follows, the scope of the term “some embodiments” is not to be so limited as to mean more than one embodiment, but rather, the scope may include one embodiment, more than one embodiment, or perhaps all embodiments.

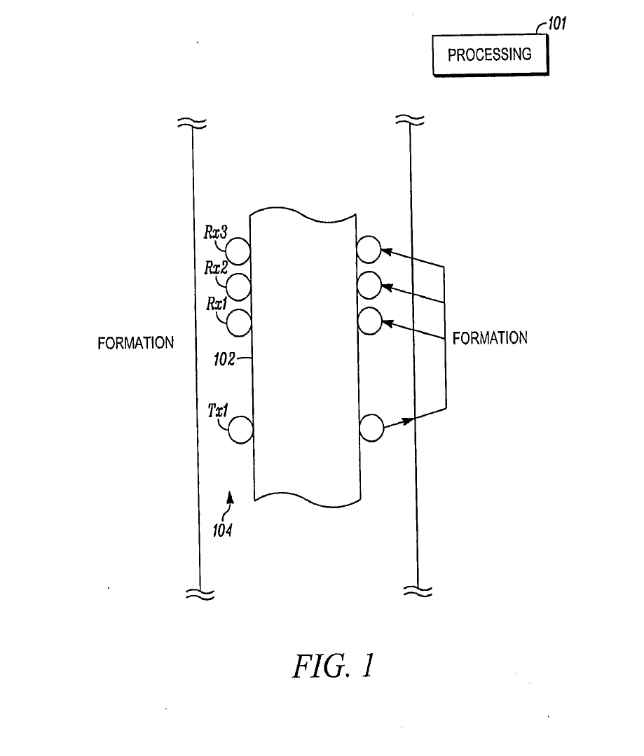

FIG. 1 illustrates, in simplified form, a well drilling and logging system according to an embodiment of the present invention, illustrating an above-ground processing system 101, and a portion of a drilling tool (102) inside borehole 104. The modules included in processing system 101 are described later. For simplicity, the drilling bit and other components of the drilling tool are not shown, and the portion of the drilling tool labeled as 102 will be referred to as tool 102. Drilling mud is present in borehole 104, but is not shown for simplicity of illustration.

In the embodiments represented by FIG. 1, tool 102 includes two acoustic transmitters, and two acoustic receiver arrays. In other embodiments, there may be more than two transmitters and two receiver arrays, positioned around tool 102. The transmitter on the left-hand side of tool 102 is labeled as Tx1, and the receivers making up the left-hand side receiver array are labeled as Rx1, Rx2, and Rx3. In practice, there is likely to be more than three receivers making up a receiver array, but only three are shown in FIG. 1 for simplicity of illustration. For some applications, for example, there may be seven receivers in a receiver array. Identical acoustic components are also illustrated on the right-hand side of tool 102, but are not labeled as such so as to not clutter the illustration. The right-hand side transmitter is fired at different times than the left-hand side transmitter.

On the right-hand side of tool 102, rays, representing acoustic waves, are shown, originating from the right-hand side transmitter, traveling into the formation and then along a direction defined by the borehole, and then received by the right-hand side receiver array. This ray tracing, of course, is an oversimplification of the actual acoustic wave propagation, but nevertheless is pedagogically helpful in describing the embodiments, and represents acoustic waves that are critically refracted.

The distance between a transmitter and the closest receiver in the corresponding receiver array may vary from embodiment to embodiment, and may be, for example, about 4.5 feet to 10 feet for various applications. The linear spacing between the receivers (meaning the acoustic receive sensors) in an array may be about 0.5 feet. The transmitter may be a broadband transmitter, and may have a programmable bandwidth from about 2 to 30 KHz. For some embodiments, the transmitter may include a multipole transducer. For some embodiments, transmitted sound pulses may alternate from low to higher bandwidth signals, where the pulses may be about 12 milliseconds apart.

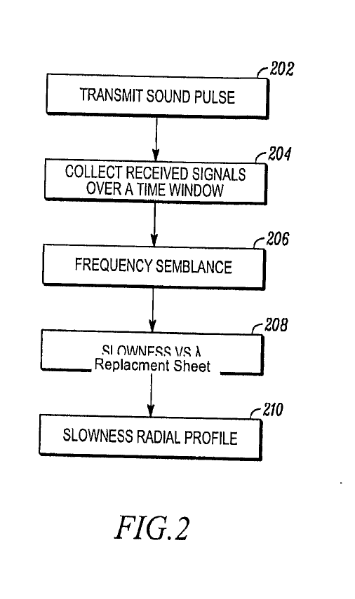

Processing system 101 is now described with reference to FIG. 2. The boxes in FIG. 2 may represent software modules running on one or more programmable processors, special purpose hardware modules, modules programmed by firmware, or some combination thereof. For simplicity, the boxes in FIG. 2 are referred to as modules.

A transmitter is excited in module 202 to send out sound pulses have some specified bandwidth or set of bandwidths, and received time samples are collected over some time window. Within module 202, the received acoustic waves are converted into an electrical analog signal, and then time sampled to provide discrete-time signals.

Module 206 performs frequency semblance, sometimes also referred to frequency coherence or phase velocity analysis. There are well-known processing algorithms to perform frequency semblance, and the disclosed embodiments are not limited to any particular method for performing frequency semblance. One such method has been disclosed in U.S. Pat. No. 6,766,252. A method according to the '252 patent may be briefly described as follows.

Assuming there are n receivers, index the receivers by an index i ranging over 1 to n, and let r(t; i) denote the received signal at receiver i. Denote the Fourier transform of r(t; i) by \hat{r}(ω; i), where r(t; i) [symbol] \hat{r}(ω; i) is a transform pair. In practice, r(t; i) is sampled in the time domain to provide a discrete-time series, and a Discrete Fourier Transform (DFT), such as for example a Fast Fourier Transform (FFT), is applied to the discrete time series to approximate the Fourier transform. The result is that \hat{r}(ω; i) is approximated at discrete values of ω, which may be referred to as frequency bins. However, for ease of discussion, it is convenient to describe frequency semblance as if r(t; i) were a continuous-time function, and \hat{r}(ω; i) was its Fourier transform with ω a continuous-frequency variable. However, the term frequency bin may still be used to refer to ω even if ω is considered a continuous variable.

Form the n dimensional column vector r̅(ω) from the \hat{r}(ω; i) where the i^{th} component of r̅(ω) is \hat{r}(ω; i). This may be repeated for a sequence of received signals due to a sequence of transmitted pulses, so that during some time window, there are multiple r̅(ω) computed for each frequency bin. Accordingly, one may introduce another index so that r̅(ω; j) is the calculated r̅(ω) for the j^{th} received signal in a sequence of received signals. A sampled-data correlation matrix R(ω) for each frequency bin ω may be formed over the sequence of signals, defined as

$$R ( ω ) {=}^{def} {\sum }_{j} \vec{r} ( ω : j ) {\vec{r} ( ω : j )}^{†} ,$$

where the index j runs over the sequence of signals, and † denotes complex conjugate transpose.

Assuming R(ω) is full rank, its eigenvectors span an n dimensional space, and R(ω) may be written as

R(ω)=Σᵢ₌₁ⁿΛᵢ(ω)eᵢ(ω)eᵢ^{†}(ω),

where the eigenvalues Λᵢ(ω) are real and may be assumed to be ordered from increasing to decreasing value, and eᵢ(ω) are the eigenvectors. Some of the eigenvectors may be chosen to span a subspace, which may be termed the noise space. For example, a noise space [symbol] may be defined as

$$𝒩 {=}^{def} lin span \{ {e}_{i} ( ω ) , i = k , k + 1 , … , n \} ,$$

where k is some integer greater than one but not greater than n. For example, k may be chosen so that the eigenvalue Λₖ(ω) is less than some threshold. One may refer to the subspace orthogonal to the noise space as the signal space [symbol] .

A semblance plot may be generated by considering the projection of an n dimensional test vector w̅(ω; s) onto the noise space [symbol] , where the test vector has components

$${[ \vec{w} ( ω ; s ) ]}_{i} {=}^{def} exp \{ \sqrt{- 1} ( i - 1 ) ω sd \} , i = 1 , 2 , … , n ,$$

where s is the slowness variable and d is the distance between the receive sensors in the receiver array. As s is varied, the projection of w̅(ω; s) onto the noise space [symbol] is calculated. Denote this projection as w̅(ω; s; [symbol] ). A relatively small value for the norm ∥ w̅(ω; s; [symbol] )∥ indicates that the test vector is estimated to be in the signal space [symbol] , and a relatively large value indicates that the test vector is estimated to be in the noise space [symbol] . Accordingly, an objective function may be chosen so that a large value for the objective function indicates that the test vector is estimated to be in the signal space, and a small value indicates that the test vector is estimated to be in the noise space. Let O(•) denote an objective function. The values O(∥ w̅(ω; s; [symbol] )∥) may be viewed as the semblance values, or frequency coherence values, and a semblance plot may be generated in the (ω, s) coordinate space. As one example, the objective function may be chosen as the reciprocal of ∥ w̅(ω; s; [symbol] )∥.

The discussion above is merely one example for generating semblance values. Methods other than using w̅(ω; s; [symbol] ) may be used to generate these values. More generally, semblance values may be represented by C(ω; s), and plots of C(ω; s) may be made in the (ω, s) coordinate space.

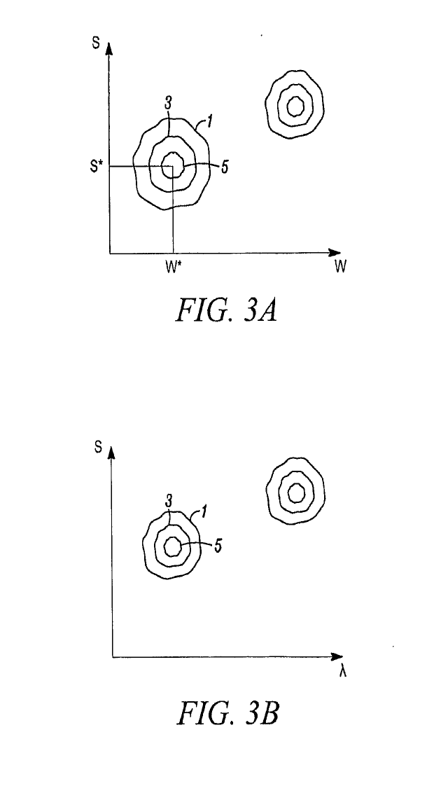

Semblance may be illustrated by displaying various curves of constant semblance values. This concept is illustrated in FIG. 3A. FIG. 3A is introduced merely for ease of discussion, and does not represent actual semblance values and contour plots. Accordingly, the slowness scale and frequency scale need not be quantified.

A set of three contours for semblance values 5, 3, and 1 is shown in FIG. 3A. Automatic routines may be developed to find sets of such contours, and may determine the maximum slowness for particular values of frequency. For example, in FIG. 3A, the maximum semblance for the set of contours under discussion is denoted as s*, and the frequency value for this maximum semblance is denoted as ω*. Such values of maximum semblance for particular frequencies may be used to study the velocity of sound in the formation, which may provide information about the formation.

These letters patent teach that providing semblance values in the (λ, s) coordinate space, where λ is wavelength, is useful for providing acoustic radial profiles of the formation. This transformation is represented by module 208. It is believed that providing semblance values in (λ, s) coordinate space is novel. Such transformed semblance plot is illustrated in FIG. 3B, and may be obtained by using the relationship λ=2π/ωs. This relationship provides for a transformation

C(ω;s) [symbol] Ĉ(λ;s),

where Ĉ(λ; s) denotes the semblance values in (λ, s) coordinate space. For example, given C(ω; s), Ĉ(λ; s) may be calculated by

\hat{C}(λ;s)=C(ω;s)]_{ω=2π/λs}.

Such a transformation will, in general, alter the shape of the contour lines.

These letters patent teach that the usefulness of the semblance in (λ, s) coordinate space in providing an acoustic radial profile is that it has been observed that the wavelength parameter is well correlated with the radial penetration depth of the acoustic wave into the formation corresponding to that wavelength parameter. One may express this by the relationship D=ƒ(λ), where D is the radial penetration depth, and ƒ(•) may be approximated by a non-random function. In particular, it has been observed that this function is close to ƒ(λ)=αλ, where α is close to 1. In particular, one may take D=λ as a fairly decent approximation.

Utilizing this observation, the slowness may be measured at various depths, thereby providing an acoustic radial profile of the formation. These profiles may be generated at various azimuth directions about the tool, but utilizing variously positioned transmitters and correspondingly positioned receiver arrays, so that a 3-D type profile may be generated during drilling. Module 210 represents the generation of such profiles.

Such profiles may provide important real-time information about the formation, which may aid in drilling. One such example is geo-steering, where for some oil fields it is necessary to drill in a near horizontal direction bounded by particular formation layers. In such applications, a detailed radial profile of the bounding formation layers may not be necessary, but rather, a gross estimate of how close the drilling tool is to such formation layers may be sufficient to properly steer the drilling tool in between the desired formation layers.

Various modifications may be made to the disclosed embodiments without departing from the scope of the invention as claimed below. Throughout the description of the embodiments, various mathematical relationships are used to describe relationships among one or more quantities. For example, a mathematical relationship or mathematical transformation may express a relationship by which a quantity is derived from one or more other quantities by way of various mathematical operations, such as addition, subtraction, multiplication, division, etc. Or, a mathematical relationship may indicate that a quantity is larger, smaller, or equal to another quantity. These relationships and transformations are in practice not satisfied exactly, and should therefore be interpreted as “designed for” relationships and transformations. One of ordinary skill in the art may design various working embodiments to satisfy various mathematical relationships or transformations, but these relationships or transformations can only be met within the tolerances of the technology available to the practitioner.

Accordingly, in the following claims, it is to be understood that claimed mathematical relationships or transformations can in practice only be met within the tolerances or precision of the technology available to the practitioner, and that the scope of the claimed subject matter includes those embodiments that substantially satisfy the mathematical relationships or transformations so claimed.

What is claimed is:

1. A method comprising:
transmitting acoustic signals from a tool in a borehole;
receiving the transmitted acoustic signals at a receiver array to provide a set of received time signals; and
performing a frequency semblance on the set of received time signals to provide a set of semblance values as a function of slowness and wavelength.

2. The method as set forth in claim 1, further comprising:
providing a radial distance profile of slowness based upon the set of semblance values.

3. The method as set forth in claim 2, wherein the radial distance profile is provided for multiple azimuths relative to the tool.

4. The method as set forth in claim 1, wherein performing the frequency semblance comprises:
providing an intermediate set of semblance values as a function of slowness and frequency; and
transforming the intermediate set of semblance values into the set of semblance values.

5. The method as set forth in claim 1, further comprising:
steering the tool in real-time based upon the set of semblance values.

6. An apparatus comprising a processing system to
perform a frequency semblance on a set of received time signals r(t; i), i=1, 2, . . . , n, where n is an integer and t is a time index, to provide a set of semblance values C(ω; s) in (ω, s) coordinate space, where ω is frequency (in radians) and s is slowness; and
provide a set of semblance values Ĉ(λ; s) in (λ, s) coordinate space, where λ is wavelength and where Ĉ(λ; s)=C(ω; s)]_{ω=2π/λs}.

7. The apparatus as set forth in claim 6, the processing system to provide a radial profile based upon the set of semblance values Ĉ(λ; s) and a function mapping wavelength to radial depth.

8. The apparatus as set forth in claim 7, wherein the radial profile is provided at multiple azimuths.

9. The apparatus as set forth in claim 7, further comprising:
a tool comprising an acoustic array of n receivers to provide the set of received time signals.
